(19) United States
(12) Patent Application Publication
(10) Pub. No.: US 2012/0103268 A1
(43) Pub. Date: May 3, 2012

(54) Small Animal Bedding Composed of Paper Manufacture From Cellulose and Polypropylene Fibers

(75) Inventor: Edward F. Owens, Ellicott City, MD (US)

(73) Assignee: AMERICAN WOOD FIBERS, Columbia, MD (US)

(21) Appl. No.: 13/279,492

(22) Filed: Oct. 24, 2011

Related U.S. Application Data
(60) Provisional application No. 61/407,287, filed on Oct. 27, 2010.

(51) Int. Cl. A01K 1/015; A01K 29/00

(52) U.S. Cl. 119/172

(57) ABSTRACT

A bedding material for use in small animal cages or the like comprises a hydrophilic cellulose fiber paper coated with a hydrophobic polypropylene coating. The bedding material is made from a combination of one or more of unused coffee filter paper and tea filter paper, air laid materials, and rayon which is shredded to produce a bedding material of a preferred size and texture. The material has a wet strength that keeps the fiber paper from fusing together when exposed to fluids but rather causes the fluids to wick out over a relatively large area for the bedding material to quickly dry. This prevents the buildup of ammonia and other unwanted odors.

### CROSS-REFERENCE TO RELATED APPLICATIONS

U.S. provisional patent application 61/407,287 filed Oct. 27, 2010.

### STATEMENT REGARDING FEDERALLY SPONSORED RESEARCH

Not Applicable.

### BACKGROUND OF THE INVENTION

This invention relates to bedding materials for small animals; and more particularly, to a bedding made from coffee filters, tea bag filter papers, rayon, and air laid materials.

Coffee filters and tea bag filter papers are made from a combination of cellulose and polypropylene fibers as described, for example, in U.S. Pat. No. 5,496,573. These bags and filters have a very high wet strength and good filtering properties. However, they are seldom recycled because they cannot be re-pulped using conventional paper re-pulping or recycling equipment. Several patents have been issued which are directed to methods for developing a filter paper that can be re-pulped. But, it has been found that the methods described in them are not widely used. Moreover, it has further been found that with round coffee filters, which are manufactured from rolls of paper, as much as 50% of the paper is disposed of as waste.

Air laid paper products include cleaning wipes, baby wipes, and similar products.

Such products are textile like materials having a non-woven fabric made from a fluff pulp. Significant characteristics of fluff pulp are its bulk and water absorbency. Air laid paper does not use water as a carrying medium for the fibers, and the structure is isotropic. The raw material comprises long fibered softwood fluff pulp which is defribrized in a hammermill. Defibrizing frees the fibers from each other before the material is fed into a paper machine.

Rayon is a semi-synthetic or artificial regenerated cellulose fiber. Among its properties are high absorbency and its uses include diapers, towels, and yarn.

Small animals such as hamsters, rats, mice, guinea pigs, ferrets, rabbits, gerbils, etc. are typically housed in cages in the home, pet shop, or laboratory. A nesting or bedding material is placed on the bottom of the cages. Heretofore, this material, in many instances is made from fibers collected from the waste created by pulp and paper mills, and in some instances the bedding made from this material has been found to be harmful to animals.

The present invention is directed to an animal bedding and a method of manufacturing animal bedding from the components above described, especially using those products which otherwise become waste.

### BRIEF SUMMARY OF THE INVENTION

The present invention is directed to an improved bedding and nesting material for small animals. The bedding and nesting material is made from coffee filter and tea bag paper, rayon, and air laid materials, including products made from these materials. In particular, the bedding material is made from unused and/or leftover bags, filter papers, wipes, and similar products.

The bedding material comprises, in combination, hydrophilic cellulose fibers with a hydrophobic polypropylene coating. The material therefore has a wet strength that prevents fibers of the material from fusing together due to exposure to fluids such as animal urine and drinking water, or other liquids, in the cage. Rather, the bedding material of the present invention causes these fluids to spread out and wick into a relatively large area of the bedding material. This allows the bedding material to dry quicker and reduce the buildup of ammonia and other odors in the animal's cage; which conditions are a major complaint with conventional beddings and bedding material.

Other objects and features will be in part apparent and in part pointed out hereafter.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Coffee filter papers and tea bag filter papers are made from a combination of cellulose and polypropylene fibers. The papers have a very high wet strength and good filtering properties. However, for various reasons, these papers are typically not recycled. Similarly, rayon and air laid paper used in products such as various types of wipes, and which also have high water absorbency or wet strength, are typically not recycled either.

The properties which make these materials good for use as coffee and tea filters, wipes, etc., also make the papers well suited for small animal nesting and bedding material. In accordance with the invention, the paper not used during the manufacture of the bags, filters, and wipes, etc., or which are unused after their manufacture, now provide material for making a nesting and bedding material for use in small animal cages. In some applications, virgin, unprocessed papers are combined with the unused waste paper material.

In manufacturing the bedding material, unused or waste paper materials made from the various components are first collected. Next, the material (virgin and waste paper) is shredded in a shredder (not shown) to produce a bedding material of a preferred size and texture. The shredded material is then placed in bags or other containers and sold or delivered to an end user such as a pet store, animal shelter, laboratory, etc. where small animals are housed. The bedding material is then placed in the cages for the animals and replaced on a periodic basis.

The bedding material of the present invention is superior in performance to the traditional paper animal beddings for a number of reasons.

First, traditional small animal bedding material is mainly composed of short fibers product sources. This material is collected from the discharge systems at pulp and paper mills; and, as a result, has in some instances been found to be harmful to small animals because of the chemicals contained in the discharge. However, the bedding material of the present invention is not first processed through a discharge system; and, accordingly, has not been found to include harmful agents.

Second, the bedding material includes, in combination, hydrophilic cellulose fibers with a hydrophobic polypropylene coating. Together these provide a wet strength that prevents the fiber paper from fusing together because of fluids such as animal urine, and spilled drinking water or other fluids introduced into the animal's cage. Instead, the bedding material of the present invention allows the water to spread out and wick over a large area of the material. This promotes quick drying of the fluids which, in turn, significantly reduces the buildup of ammonia and other odors in the animal's cage. As noted, this has been a major complaint of previous bedding materials.

Third, the polypropylene coating also reduces the dust released from the bedding during cage cleanup and maintenance by a caretaker, or caused by the burrowing and nesting activities of the animal or animals housed in a cage. This is because the polypropylene coating on the cellulose fibers “locks in” short cellulose fibers that can cause dust and prevents their release into the atmosphere.

Fourth, the wicking characteristics of the fibers of the bedding material of the present invention, together with the material's quick drying capability, make it easier to dye the bedding material so that it is available in a range of colors.

Fifth, the low bulk density of the bedding material reduces package weight. Further, the high loft of the material allows fecal material to sift to the bottom of the cage and be less visible between bedding changes.

Finally, during testing, it has been found that when the bedding material of the present invention is introduced into a small animal cage, the animal or animals housed therein have shown a preference for it as a bedding and nesting material over the materials previously available on the market, as well as over wood shavings or other paper based bedding materials.

In view of the above, it will be seen that the several objects and advantages of the present disclosure have been achieved and other advantageous results have been obtained.

Having thus described the invention, what is claimed and desired to be secured by Letters Patent is:

1. A bedding material for use in small animal cages or the like comprising, in combination, a hydrophilic cellulose fiber paper coated with a hydrophobic polypropylene coating, the resulting bedding material having a wet strength that keeps the fiber paper from fusing together when exposed to fluids such as animal urine and water but to rather cause the fluids to wick out over a relatively large area of the bedding material for the material to relatively quickly dry and thereby reduce the buildup of ammonia and other odors in an animal's cage.

2. The bedding material of claim 1 in which the bedding material is comprised of unused coffee filter paper and tea filter paper which is shredded to produce a bedding material of a preferred size and texture.

3. The bedding material of claim 2 further comprising air laid materials.

4. The bedding material of claim 3 further comprising rayon.

5. The bedding material of claim 1 which further reduces dust released from the bedding as a result of the polypropylene coating on the cellulose fibers preventing the release of short cellulose fibers which can cause the dust.

6. The bedding material of claim 4 which can be dyed so to produce a bedding material of one of a variety of colors.

7. The bedding material of claim 1 having a low bulk density so to reduce the weight of packaged bedding material.

8. The bedding material of claim 1 having a high loft which allows animal fecal material to sift to the bottom of a cage and be less visible.

9. The bedding material of claim 2 further including combining virgin filter paper with unused coffee filter paper and tea filter paper to produce the bedding material.

10. A method of making a bedding material for use in animal cages comprising combining a hydrophilic cellulose fiber paper coated with a hydrophobic polypropylene coating with the resulting bedding material having a wet strength that keeps the fiber paper from fusing together when exposed to fluids such as animal urine and water but rather causes the fluids to wick out over a relatively large area of the bedding material so to facilitate relatively quick drying thereof which reduces the buildup of ammonia and other undesirable odors in an animal's cage.

11. The method of claim 10 further including shredding unused coffee filter paper and tea filter paper to produce a bedding material of a desired size and texture.

12. The method of claim 11 further including shredding an air laid material together with the coffee filter paper and tea filter paper to produce the bedding material.

13. The method of claim 11 further including shredding rayon together with the coffee filter paper and tea filter paper to produce the bedding material.

14. The method of claim 11 further including shredding an air laid material and rayon together with the coffee filter paper and tea filter paper to produce the bedding material.

15. The method of claim 11 in which the polypropylene coating on the cellulose fibers of the bedding material prevents the release of short cellulose fibers thereby reducing the amount of dust released by the bedding material.

16. The method of claim 10 further including dyeing the bedding a desired color.

17. The method of claim 10 to produce a bedding material having a low bulk density so to reduce the weight of the bedding material.

18. The method of claim 10 to produce a bedding material having a high loft which allows animal fecal material to sift to the bottom of a cage and be less visible.

19. The method of claim 11 further including combining virgin filter paper with unused coffee filter paper and tea filter paper to produce the bedding material.
